(19) United States
(12) Patent Application Publication
(10) Pub. No.: US 2024/0051793 A1
(43) Pub. Date: Feb. 15, 2024

(54) ELEVATOR PIT MAINTENANCE SYSTEMS

(71) Applicant: Otis Elevator Company, Farmington, CT (US)

(72) Inventors: Jim Creel, Hemingway, SC (US); Ken Litteral, Florence, SC (US); Ryan Keane, Wilbraham, MA (US)

(21) Appl. No.: 17/888,029

(22) Filed: Aug. 15, 2022

(51) Int. Cl. B66B 5/00; B66B 5/02

(52) U.S. Cl. CPC B66B 5/0062; B66B 5/025; B66B 5/16

(57) ABSTRACT

Safety systems and methods for elevator systems include an elevator car configured to travel along an elevator shaft, a pit at a bottom of the elevator shaft, and a governor having an energizable actuator configured to be continuously energized from a time of activation to a time of reset, the governor configured to stop downward movement of the elevator car along the elevator shaft after the time of activation until the time of reset, with energizing of the energizable actuator being initiated from an electrical trigger mechanism proximate the pit of the elevator shaft.

### BACKGROUND

The subject matter disclosed herein generally relates to elevator systems and, more particularly, to access and maintenance systems for elevator pit maintenance.

Elevator systems include locking mechanisms that are useable by mechanics, technicians, and other authorized persons. The locking mechanisms can be part of lintels or door columns or traps inside the car of the elevator systems and thus may be easily accessible by anyone. However, it may be required by safety regulations and/or advantageous to prevent access to and/or operation of the elevator locking mechanisms at certain times (e.g., when a technician or mechanic is performing a maintenance operation) or when authorized access is not proper. Accordingly, devices that prevent access to the elevator system locking mechanisms may be desirable.

Further, for certain maintenance operations, such as performed in a pit or within an elevator shaft, it may be useful to have safety mechanisms in place to prevent injury or other unwanted events to occur when a technician or the like is physically present within an elevator shaft or hoistway. Although various mechanisms exist to ensure the safety of personnel, additional safety mechanisms may be beneficial.

### SUMMARY

According to some embodiments, safety systems for elevator systems are provided. The safety systems include an elevator car configured to travel along an elevator shaft, a pit at a bottom of the elevator shaft, and a governor having an energizable actuator configured to be continuously energized from a time of activation to a time of reset, the governor configured to stop downward movement of the elevator car along the elevator shaft after the time of activation until the time of reset, with energizing of the energizable actuator being initiated from an electrical trigger mechanism proximate the pit of the elevator shaft.

In addition to one or more of the features described above, or as an alternative, further embodiments of the safety systems may include that the governor is a car-mounted governor attached to the elevator car.

In addition to one or more of the features described above, or as an alternative, further embodiments of the safety systems may include that the electrical trigger mechanism is electrically connected to the car-mounted governor by a traveling cable.

In addition to one or more of the features described above, or as an alternative, further embodiments of the safety systems may include that the governor is arranged in a machine room of the elevator system.

In addition to one or more of the features described above, or as an alternative, further embodiments of the safety systems may include that the electrical trigger mechanism is at least one of a button, a switch, a lever, or a pull-cable located in the pit.

In addition to one or more of the features described above, or as an alternative, further embodiments of the safety systems may include that the electrical trigger mechanism comprises a landing door lock at a landing door proximate the pit of the elevator shaft.

In addition to one or more of the features described above, or as an alternative, further embodiments of the safety systems may include that the electrical trigger mechanism comprises a controller configured to detect that a lowest landing door along the elevator shaft is open and the elevator car is not present at the lowest landing door, and, in response to detecting the lowest landing door is open and the car is not present, causing the governor to be activated.

In addition to one or more of the features described above, or as an alternative, further embodiments of the safety systems may include that the time or reset comprises a manual resetting of the governor.

In addition to one or more of the features described above, or as an alternative, further embodiments of the safety systems may include that the governor is configured to allow upward movement of the elevator car after the energizable actuator is energized.

In addition to one or more of the features described above, or as an alternative, further embodiments of the safety systems may include that the energizable actuator is one of a solenoid, a linear actuator, a rotary actuator, a damper actuator, a latching actuator, or an electric actuator.

According to some embodiments, methods of operating elevator systems are provided. The methods include receiving, at a governor, an electrical signal to charge an energizable actuator of the governor, wherein the energizable actuator is configured to be continuously energized from a time of activation to a time of reset and the governor is configured to stop downward movement of the elevator car along an elevator shaft after the time of activation until the time of reset and wherein the time of activation is the receiving of the electrical signal, charging and energizing the energizable actuator of the governor with electrical power in response to the received electrical signal, and maintaining the energizable actuator in an energized state from the time of activation to the time of reset, with the electrical signal being provided from an electrical trigger mechanism located proximate the pit of the elevator shaft.

In addition to one or more of the features described above, or as an alternative, further embodiments of the methods may include that the governor is a car-mounted governor attached to the elevator car.

In addition to one or more of the features described above, or as an alternative, further embodiments of the methods may include that the electrical trigger mechanism is electrically connected to the car-mounted governor by a traveling cable.

In addition to one or more of the features described above, or as an alternative, further embodiments of the methods may include that the governor is arranged in a machine room of the elevator system.

In addition to one or more of the features described above, or as an alternative, further embodiments of the methods may include that the electrical trigger mechanism is at least one of a button, a switch, a lever, or a pull-cable located in the pit.

In addition to one or more of the features described above, or as an alternative, further embodiments of the methods may include that the electrical trigger mechanism comprises a landing door lock at a landing door proximate the pit of the elevator shaft.

In addition to one or more of the features described above, or as an alternative, further embodiments of the methods may include detecting an open state of a lowest landing door along the elevator shaft and detecting that the elevator car is not present at the lowest landing door, and, in response to detecting the lowest landing door is open and the car is not present, causing the governor to be activated.

In addition to one or more of the features described above, or as an alternative, further embodiments of the methods may include that the time of reset comprises a manual resetting of the car-mounted governor.

In addition to one or more of the features described above, or as an alternative, further embodiments of the methods may include that the car-mounted governor is configured to allow upward movement of the elevator car after the energizable actuator is energized.

In addition to one or more of the features described above, or as an alternative, further embodiments of the methods may include that the energizable actuator is a solenoid.

The foregoing features and elements may be combined in various combinations without exclusivity, unless expressly indicated otherwise. Features which are described in the context of separate aspects and embodiments may be used together and/or be interchangeable. Similarly, features described in the context of a single embodiment may also be provided separately or in any suitable subcombination. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2 is a schematic illustration of a landing floor of an elevator system with a hall call panel that may employ various embodiments of the present disclosure;

FIG. 3 is a schematic illustration of an elevator system in accordance with an embodiment of the present disclosure;

FIG. 4A is a schematic illustration of a car-mounted governor in accordance with an embodiment of the present disclosure;

FIG. 4B is a schematic illustration of the car-mounted governor of FIG. 4A, in a tripped state;

FIG. 5 is a flow process for operation of an elevator system in accordance with an embodiment of the present disclosure; and

FIG. 6 is a flow process for operation of an elevator system in accordance with an embodiment of the present disclosure

### DETAILED DESCRIPTION

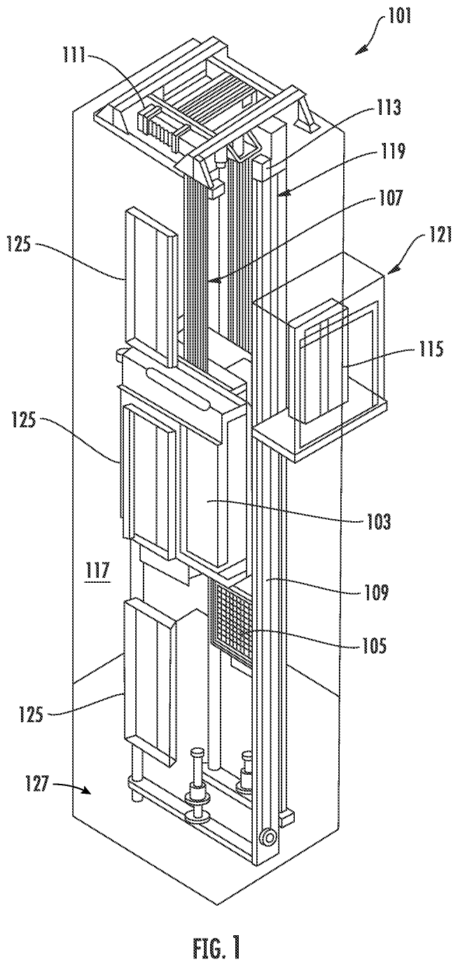

FIG. 1 is a perspective view of an elevator system 101 including an elevator car 103, a counterweight 105, a roping 107, a guide rail 109, a machine 111, a position encoder 113, and an elevator controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator hoistway or shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The elevator controller 115 is located, as shown, in a controller room 121 of the elevator shaft 117 and is configured to control the operation of the elevator system 101, and particularly the elevator car 103. For example, the elevator controller 115 may provide drive signals to the machine 111 to control the acceleration, deceleration, leveling, stopping, etc. of the elevator car 103. The elevator controller 115 may also be configured to receive position signals from the position encoder 113. When moving up or down within the elevator shaft 117 along guide rail 109, the elevator car 103 may stop at one or more landings 125 as controlled by the elevator controller 115. Although shown in a controller room 121, those of skill in the art will appreciate that the elevator controller 115 can be located and/or configured in other locations or positions within the elevator system 101. The elevator shaft 117 includes a pit 127 which may include various components and/or mechanical systems associated with the elevator system 101. Such components and/or mechanical systems in the pit 127 may require maintenance to be performed thereon.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

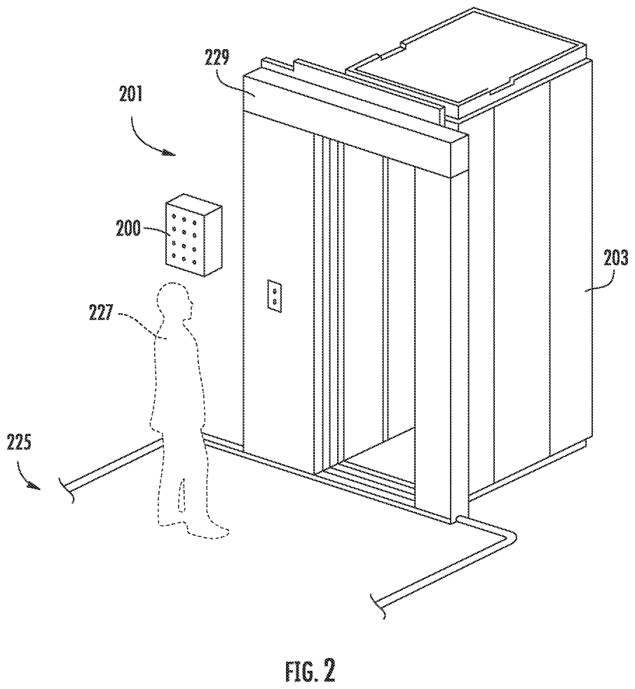

FIG. 2 is a schematic illustration of an elevator system 201 that may incorporate embodiments disclosed herein. As shown in FIG. 2, an elevator car 203 is located at a landing 225. The elevator car 203 may be called to the landing 225 by a passenger or mechanic 227 that desires to travel to another floor within a building or perform maintenance on a portion of the elevator system 201. In some situations, the mechanic 227 may wish to lock a feature of the elevator system, e.g., the elevator doors, an elevator trap, etc., such that the feature(s) cannot be opened or closed (e.g., to prevent unauthorized persons from accessing the elevator system 201 or portions thereof). For example, such situation may arise when the mechanic 227 wishes to access the elevator car and/or shaft to perform maintenance. Such control or locking can be achieved by a lock hole in a landing door lintel 229 of the elevator system 201 (which may be located at one or more landings 225).

For example, in some configurations, an access control module 200 (e.g., an emergency and test operation module (“ETOM”) or other user control interface) can be located at one or more landings 225 of the elevator system. The access control module 200 can include one or more electrical components that are configured to enable control of an associated elevator system. For example, the access control module 200 can include options for a mechanic or other authorized person to call and/or move elevator cars within an elevator shaft, lock and unlock various locks of the elevator system (e.g., lintel door locks, etc.). The access control module 200 further can enable a mechanic or other authorized person (e.g., emergency personnel) to control and move an elevator car for various reasons.

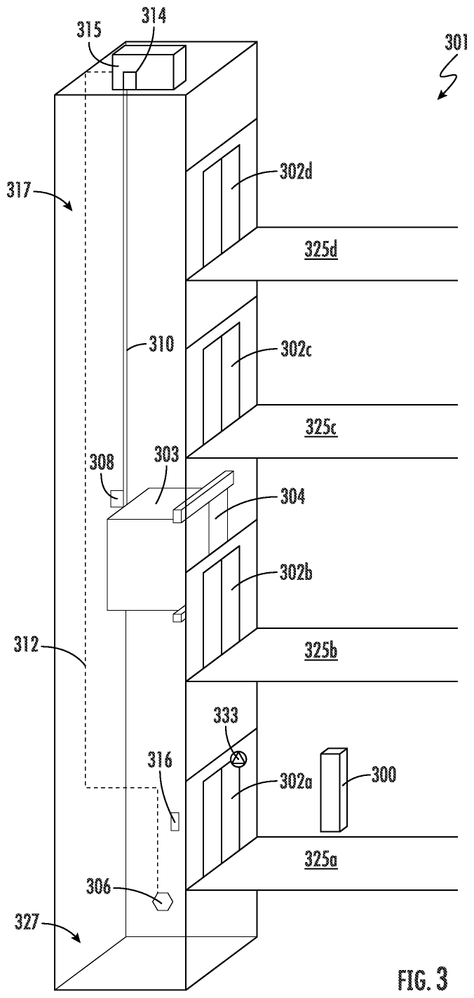

Turning now to FIG. 3, a schematic illustration of an elevator system 301 configured in accordance with a non-limiting embodiment of the present disclosure is shown. The elevator system 301 includes an elevator car 303 movable within an elevator shaft 317 between a plurality of landings 325a, 325b, 325c, 325d. As shown, a first landing 325a is located at the bottom of the elevator shaft 317, a second landing 325b is located above the first landing 325a, a third landing 325c located above the second landing 325b, and a fourth landing 325d located above the third landing 325c (e.g., at the top of the elevator shaft 317 in this illustrative embodiment). Although shown with four landings, FIG. 3 is merely provided for illustrative and explanatory purposes and any number of landings can be located along an elevator shaft, as will be appreciated by those of skill in the art.

The first landing 325a includes a respective first landing door 302a, the second landing 325b includes a respective second landing door 302b, the third landing 325c includes a respective third landing door 302c, and the fourth landing 325d includes a respective fourth landing door 302d. The landing doors 302a, 302b, 302c, 302d are configured to be openable only when the elevator car 303 is located at the respective landing door 302a, 302b, 302c, 302d, as will be appreciated by those of skill in the art. However, in certain instances, such as for maintenance and/or in emergencies, access to the elevator shaft 317 through a landing door 302a, 302b, 302c, 302d may be desirable or required. As such, the elevator system 301 is equipped with an access control module 300, similar to that described above. The access control module 300 can be used by a mechanic or other authorized person to control the elevator car 303 within the elevator shaft 317. As will be appreciated by those of skill in the art, during normal elevator operation, the landing doors 302a, 302b, 302c, 302d may be configured to operate through interaction with an elevator car door 304 of the elevator car 303.

At times, maintenance may be required to be performed on one or more parts of the elevator system 301. For example, inspection, repair, replacement, or other maintenance operation may be required to be performed in a pit 327 of the elevator shaft 317. To access the pit 327, a maintenance person will need to open the landing door 302a at the lowest landing 325a and also move the elevator car 303 away from the pit 327, to allow for access thereto (e.g., as shown schematically in FIG. 3).

As illustrated in FIG. 3, only the first landing 325a and the associated first landing door 302a includes a lock 333 that enables unlocking of the first landing door 302a. The lock 333 of the first landing door 302a can be, in some embodiments, controlled by the access control module 300 that is also located on the first landing 325a. In other embodiments, such as when the access control module 300 is not present, the lock 333 of first landing door 302a may be mechanically operated using a triangular key or the like, as will be appreciated by those of skill in the art. As shown, in the present embodiment, none of the other landings/landing doors 325b-d/302b-d, include a lock. In such a configuration, for example, the only landing door that is openable when the elevator car 303 is not present at the respective landing door is the first landing door 302a. Or, stated another way, the second, third, and fourth landing doors 302b, 302c, 302d may be permanently locked except when the elevator car 303 is located at the respective landing 325b, 325c, 325d. It will be appreciated that this is merely an example, and in other configurations, some set or all landings/landing doors may include respective locks and/or may be controlled (openable) by the access control module 300.

The access control module 300 is operably connected to the landing door lock 333 on the first landing 325a. The access control module 300 can enable electrical control over operation and/or access to the landing door lock 333. Additionally, the access control module 300 is operably connected to an elevator controller 315 to enable control of movement of the elevator car 303 within the elevator shaft 317. The controller 315 may be arranged within a machine room associated with the elevator car 303. A mechanic or other authorized person can activate or engage the elevator system into a maintenance mode of operation which can call the elevator car 303 to the appropriate landing/landing door (e.g., move the elevator car 303 away from the first landing door 302a). In some embodiments, the movement of the elevator car 303 upon activation of the maintenance operation can be automated, moving the elevator car 303 to an appropriate predetermined maintenance position. Further, in some embodiments, the access control module 300 can be configured to enable adjustment (e.g., manual movement) of the elevator car 303.

When the first landing door 302a is opened, and the elevator car 303 is not present at the first landing 325a, a technician, mechanic, or other authorized person may gain access to the pit 327 of the elevator shaft 317. Because being within the elevator shaft 317 can be dangerous (e.g., the elevator car 303 is above a person in the pit 327), providing sufficient safety mechanisms to prevent unwanted movement of the elevator car 303 may be desirable.

In accordance with embodiments of the present disclosure, mistake-proof mechanisms for safe pit access are provided. For example, in accordance with some embodiments of the present disclosure, a pit safety switch 306 may be provided within the pit 327 of the elevator shaft 317. The pit safety switch 306 may be a mechanical switch, button, toggle, or the like arranged within the pit 327. The pit safety switch 306 may be electrically coupled to a car-mounted governor 308 of the elevator car 303. The pit safety switch 306 may be configured to allow control or activation of the car-mounted governor 308 or a portion thereof. For example, in some embodiments, by activating the pit safety switch 306, the car-mounted governor 308 may prevent downward movement of the elevator car 303 within the elevator shaft 317.

The pit safety switch 306 may be referred to as an electrical trigger mechanism that is located proximate the pit 327 of the elevator shaft 317. The electrical trigger mechanism, in accordance with embodiments of the present disclosure, can take a variety of forms. One example is the pit safety switch 306, which may be a button, switch, lever, pull-cable, or the like, that allows for manual actuation and operation. In some embodiments, the electrical trigger mechanism may be coupled to the landing door lock 333, such that unlocking of the landing door lock 333 operates similar to an actuation of a switch (e.g., pit safety switch 306). In some embodiments, the electrical trigger mechanism may be performed using the access control module 300 and/or the elevator machine 315, with sensors configured to detect operation of the first landing door 302a and the position of the elevator car 303. For example, as shown in FIG. 3, an elevator detection sensor 314 may be arranged within the elevator shaft 317 proximate the pit 327 to detect the presence (or absence) of the elevator car 303. Other types of sensors that may be used in embodiments in accordance with the present disclosure may include, without limitation, sensors on a traveling rope, sensors in or on an elevator machine, digital-type sensors associated with the controller 315, proximity sensors, motion sensors, and the like. In some such configurations, if the controller(s) 315, 300 detect opening of the of the first landing door 302a without the presence of the elevator car 303 at the first landing door 302a, then an electrical signal may be generated to perform the same functionality of a push-button switch or the like.

The elevator car 303 includes the car-mounted governor 308 to control a speed of the elevator car 303 in the elevator shaft 317. The car-mounted governor 308 may be connected to an elevator safety to slow and/or stop the movement of the elevator car 303 in the case of an overspeed condition. In a car-mounted governor systems, a governor cable 310 (e.g., traveling cable) is suspended from a fixed point at the top of the elevator shaft 317 (e.g., at the elevator machine 315), and passes through the car-mounted governor 308 at the elevator car 303. In some configurations, the governor cable 310 may be attached to a tension weight, located in the pit 327 at the bottom of the elevator shaft 317, to maintain tension on the governor cable 310. The governor cable 310 may include electrical communication 312 between the pit safety switch 306 and the car-mounted governor 308, such as through the elevator controller 315.

The car-mounted governor 308 may include an energizable actuator for arming and/or activation thereof. In some non-limiting embodiments, and without limitation, the energizable actuator may be a solenoid or other electrical or electromechanical device capable of being continuously charged or energized, including, but not limited to linear actuators, rotary actuators, damper actuators, latching actuators, electric actuators, and the like. Typically, such an energizable actuator is not continuously charged or active (i.e., default is an un-energized state). To arm or activate the car-mounted governor 308, electrical power is provided to the car-mounted governor 308 which will energize the energizable actuator and prepare the car-mounted governor 308 for operation/activation to control movement (or lack of movement) of the elevator car 303.

Also shown in FIG. 3 is a governor 314 arranged in a machine room or associated with the controller 315. The governor 314 may be a convention governor (e.g., as compared to the car-mounted governor 308). In some embodiments of the present disclosure, only one governor 308, 314 may be included in the system and activated or operated in accordance with embodiments of the present disclosure. As used herein, the term governor encompasses various types of emergency braking systems, including, without limitation electronic safety actuators, overspeed governors, flyball governors, car-mounted governors, machine-mounted governors, hoistway or elevator shaft mounted governors, and the like. Further, although described above with respect to detection of the lack of the elevator car at the lowest landing, it will be appreciated that the systems and processes described herein may be applied to any landing door that is opened and the elevator car is not present, and embodiments of the present disclosure are not intended to be limited to only the lowest landing of an elevator system.

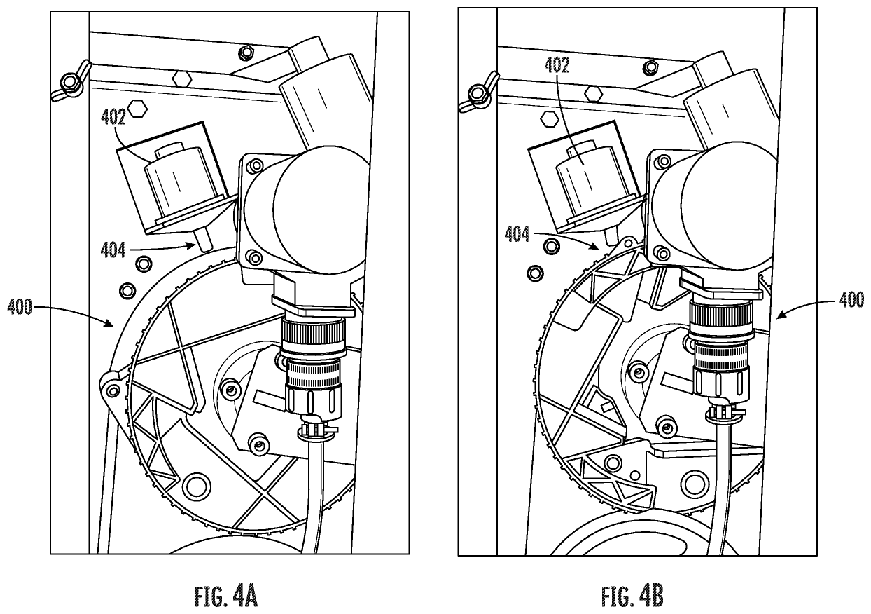

Referring now to FIGS. 4A-4B, schematic illustrations of a car-mounted governor 400 in accordance with an embodiment of the present disclosure are shown. The car-mounted governor 400 is configured to be arranged on an elevator car and control, in part, directional travel of the elevator car along guide rails or the like. The car-mounted governor 400 is an overspeed device for restricting elevator car movement when a predetermined speed is exceeded. Such governors include a switch that opens when the elevator reaches a predetermined velocity (e.g., 110% of rated speed or the like). When the switch opens, power is removed from the machine motor and brake. A braking mechanism, actuated in response to movement of the elevator car, will impede the motion of the elevator car. The switch remains open, and the elevator remains inoperable until the switch is manually reset.

In an example configuration, the car-mounted governor 400 includes a sheave coupled to a rope attached to the elevator car. The sheave moves in response to rope movement in tandem with the movement of the elevator car. The sheave drives a shaft or spindle coupled to an actuation mechanism. The actuation mechanism may be a set of flyballs or flyweights adapted to extend radially when a predetermined level of centrifugal force is applied to them. Radial extension of the flyballs or flyweights causes them to contact an overspeed switch. When the overspeed switch is actuated, the power to the motor and motor brake is cut, thereby causing the motor brake to apply a braking force on the motor shaft. If the elevator car continues to increase in speed, a tripping assembly is triggered by the flyweights. The tripping assembly actuates a mechanism to stop the governor rope. Braking of the governor rope causes the safeties to be engaged and thereby stop the car.

As shown in FIGS. 4A-4B, the car-mounted governor 400 includes an energizable actuator, illustrated as a solenoid 402, configured to cause actuation of a plunger 404. FIG. 4A illustrates the plunger 404 extended and FIG. 4B illustrates the car-mounted governor 400 in a tripped state. In accordance with embodiments of the present disclosure, the solenoid 402 may be electrically connected to a pit safety switch located in a pit of an elevator shaft, such as shown and described above with respect to FIG. 3. When the pit safety switch is activated by a person in the pit, an electrical signal may be transmitted along an electrical communication to the car-mounted governor 400. By operating the pit safety switch, the solenoid 402 may be energized. When the solenoid 402 is energized, the plunger 404 is positioned to prevent downward movement of the elevator car.

Conventionally, the solenoid is only energized during inspections. However, in accordance with embodiments of the present disclosure, the solenoid is configured to be continuously extended upon activation of the pit safety switch. Once active and extended, if the elevator car moves downward, the car-mounted governor 400 will activate and prevent further downward motion of the elevator car. In some embodiments, the elevator car may be permitted to move upward, even upon activation of the pit safety switch. Further, although described as being operable by activation of a pit safety switch (e.g., pit safety switch 306 shown in FIG. 3), in other embodiments, the car-mounted governor 400 may be activated through interaction with a landing door lock at the lowest level (e.g., lock 333 shown in FIG. 3). With the solenoid 402 automatically extended after activation by the pit safety switch (or other activation), any downward movement of the elevator car will immediately trip the car-mounted governor 400 and set the car on safety brakes to prevent any further downward movement.

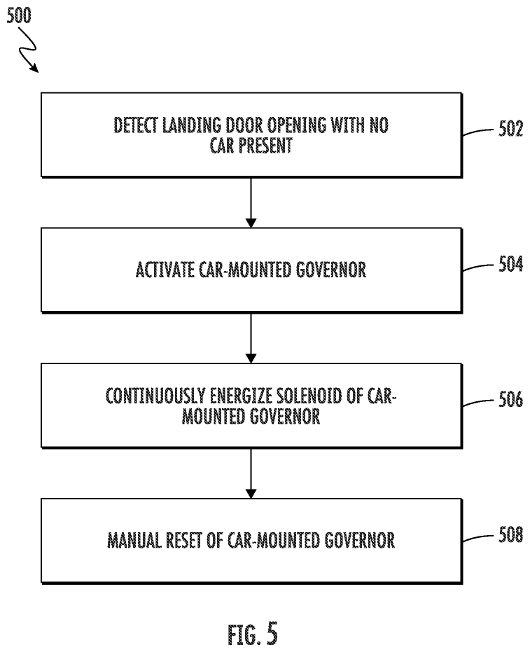

Referring now to FIG. 5, a flow process 500 for performing an operation in accordance with an embodiment of the present disclosure is shown. The flow process 500 may be implemented in elevator systems, and particularly in elevator systems as shown and described above. An elevator car is configured to travel along an elevator shaft between a plurality of floors or landings, and the elevator shaft includes a pit which may require access for maintenance or other purposes. The elevator car includes a car-mounted governor that is configured to prevent overspeed travel of the elevator car. The car-mounted governor is equipped with an energizable actuator that is configured to be continuously energized upon activation. The activation may be triggered by a mechanic or other personnel. In some embodiments, the activation of the car-mounted governor may be achieved through operation or actuation of a pit safety switch that is electrically coupled to the car-mounted governor through a traveling cable or the like.

At block 502, a controller or the like may detect an opening of a landing door when no car is present at the respective landing. The detection may be made by an elevator controller, an elevator sensing system, or the like. In some embodiments, an electrical safety chain may be broken in the event of the landing door being opened with no elevator car present. Such breaking of the electrical safety chain may cause the elevator controller to prevent normal operation of the elevator system.

At block 504, the car-mounted governor is activated into a ready state. In the ready state, the car-mounted governor is arranged to prevent downward motion of the elevator car. That is, upon downward motion, the car-mounted governor may rotate or otherwise actuate, causing one or more safety brakes to engage with a guide rail and stop motion of the elevator car. In some embodiments, once activated, the car-mounted governor may allow upward movement of the elevator car, but prevent downward movement. The activation to the ready state of the car-mounted governor may include energizing an energizable actuator of the car-mounted governor.

In accordance with some embodiments, the activation at block 504 may be initiated automatically when the system detects the lowest landing door being open and the elevator car not being present at that landing. In other embodiments, use of a triangular key or the like to unlock the landing door, when the elevator car is not present, may cause the operation of block 504. In other embodiments, a dedicated pit safety switch (e.g., as shown and described above) may be provided in a pit of the elevator shaft, and a mechanic can manually activate the operation of block 504 by operating the pit safety switch.

At block 506, the energizable actuator is continuously energized, and thus the ready state is continuously maintained. With the energizable actuator continuously energized, the elevator car will be prevented from downward motion (beyond the amount required to trigger and operate the car-mounted governor). The continuous energizing of the energizable actuator may be provided through a traveling cable or governor cable. In some embodiments, a backup battery or the like may be provided to supply electrical power to the energizable actuator in the event of a power failure in the building or the like.

After block 506, a mechanic or other person may perform a maintenance operation or activity in the pit of the elevator shaft. The operation of the car-mounted governor and continuously energized energizable actuator thereof, provide a safety mechanism to prevent downward movement of the elevator car when a person is located in the pit of the elevator shaft.

At block 508, a mechanic or technician or the like may reset the car-mounted governor. The reset may be a manual operation, to ensure that the car-mounted governor is not inadvertently deenergized.

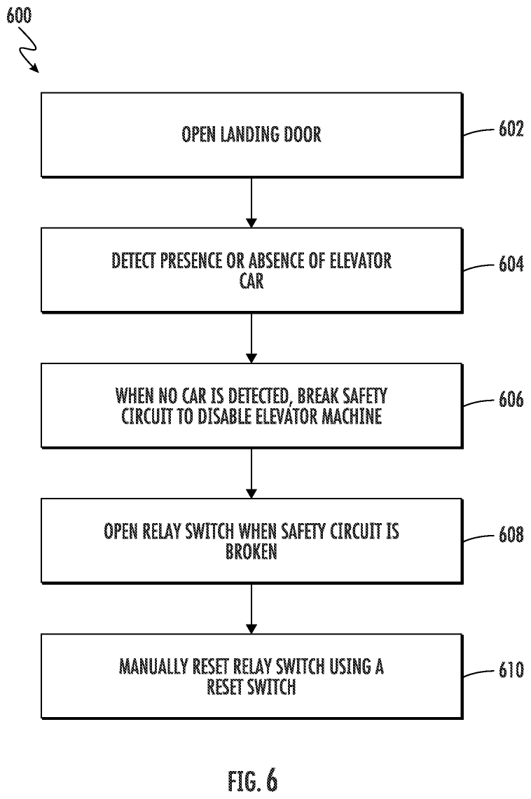

Referring now to FIG. 6, a flow process 600 for performing an operation in accordance with an embodiment of the present disclosure is shown. The flow process 600 may be implemented in elevator systems, and particularly in elevator systems as shown and described above. An elevator car is configured to travel along an elevator shaft between a plurality of floors or landings, and the elevator shaft includes a pit which may require access for maintenance or other purposes. In this embodiment, a safety circuit is electrically integrated into a landing door operation for the lowest level (i.e., closest to the pit of the elevator shaft). The safety circuit includes relay switch which is opened when the safety circuit is opened. The safety circuit is tied to operation of the landing door and detection (or lack thereof) of an elevator car present at the landing when the door opens.

For example, at block 602 a person (e.g., mechanic, technician, authorized person, etc.) may open the landing door of the lowest landing to gain access to the pit of the elevator shaft.

At block 604, a sensor is used to detect if an elevator car is present at the landing when the landing door is opened at block 602. If the elevator car is present, no action is taken.

However, at block 606, upon detection of no elevator car present, the safety circuit is broken to disable operation of the elevator machine, and thus prevent movement of the elevator car. The operation may involve dropping a brake or similar stop at the elevator machine. As such, with the safety circuit broken, the elevator car will be prevented from movement, until reset.

At block 608, the breaking of the safety circuit may involve opening a relay switch or the like. This relay switch will remain open until a reset switch is activated. The reset switch may be located in an access control module or the like (e.g., a control system not located in the elevator shaft). It will be appreciated that the relay switch may be operably coupled to a button or manual switch/trigger located in the pit (e.g., as shown and described above).

With the safety circuit broken and the relay switch open, the person may perform required tasks in the pit of the elevator shaft and the elevator car will be secured in place by the elevator machine.

At block 610, the relay switch and safety circuit may be closed/reconnected by operation of a reset switch. The reset switch, as noted above, may be located in an access control module. The reset switch may be located outside the elevator shaft, and thus to cause the reset, the person must be outside the elevator shaft.

The process 600 of FIG. 6 provides an automated and automatic safety operation that disables the elevator machine and prevents movement of the elevator car upon opening of the landing door closest to the elevator pit. This process may be in addition to including a pit safety switch (e.g., pit safety switch 306 and/or process 500). As such, multiple, redundant systems to ensuring pit safety may be provided. For example, in some embodiments, the process 600 may be performed (i.e., to disable the elevator machine in response to landing door opening with no car) and the process 500 may also be performed, to ensure no downward movement occurs through the continuously energized energizable actuator. Both processes may be performed or one or the other may be implemented.

Advantageously, embodiments provided herein provide for mistake-proof safe pit access for elevator systems. Embodiments of the present disclosure provide for an activatable car-mounted governor that is triggered from a position external to the elevator car (e.g., from the pit, from the lowest landing, etc.). In some embodiments, advantageously, a button or switch may be provided within the pit of the elevator car to provide electrical activation of the car-mounted governor. Once activated, an energizable actuator of the car-mounted governor is continuously energized until the system is reset. By continuously energizing the energizable actuator until a deactivation step is performed (e.g., manual reset), the elevator will be continuously prevented from downward movement until released. In some embodiments, the opening of the landing door, without an elevator car present, may trigger a breaking of a safety circuit to cause a machine brake to activate and stop operation of an elevator machine. As such, mistake-proof safety mechanisms are provided to ensure that an elevator car is prevented from downward movement when a person opens the lowest landing door to gain access to the elevator pit. That is, automated systems are provided to prevent movement of an elevator car (at least in a downward direction) when the lowest landing door is opened and the elevator car is not present at the landing.

As used herein, the use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity).

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

1. A safety system for an elevator system, the safety system comprising:
an elevator car configured to travel along an elevator shaft;
a pit at a bottom of the elevator shaft; and
a governor comprising an electronic safety actuator having an energizable actuator configured to be continuously energized from a time of activation to a time of reset, the governor configured to stop downward movement of the elevator car along the elevator shaft after the time of activation until the time of reset,
wherein energizing of the energizable actuator is initiated from an electrical trigger mechanism proximate the pit of the elevator shaft.

2. The safety system of claim 1, wherein the governor is a car-mounted governor attached to the elevator car.

3. The safety system of claim 2, wherein the electrical trigger mechanism is electrically connected to the car-mounted governor by a traveling cable.

4. The safety system of claim 1, wherein the governor is arranged in a machine room of the elevator system.

5. The safety system of claim 1, wherein the electrical trigger mechanism is at least one of a button, a switch, a lever, or a pull-cable located in the pit.

6. The safety system of claim 1, wherein the electrical trigger mechanism comprises a landing door lock at a landing door proximate the pit of the elevator shaft.

7. The safety system of claim 1, wherein the electrical trigger mechanism comprises a controller configured to detect that a lowest landing door along the elevator shaft is open and the elevator car is not present at the lowest landing door, and, in response to detecting the lowest landing door is open and the car is not present, causing the governor to be activated.

8. The safety system of claim 1, wherein the time of reset comprises a manual resetting of the governor.

9. The safety system of claim 1, wherein the governor is configured to allow upward movement of the elevator car after the energizable actuator is energized.

10. The safety system of claim 1, wherein the energizable actuator is one of a solenoid, a linear actuator, a rotary actuator, a damper actuator, a latching actuator, or an electric actuator.

11. A method of operating an elevator system, the method comprising:
receiving, at a governor comprising an electronic safety actuator, an electrical signal to charge an energizable actuator of the governor, wherein the energizable actuator is configured to be continuously energized from a time of activation to a time of reset and the governor is configured to stop downward movement of the elevator car along an elevator shaft after the time of activation until the time of reset and wherein the time of activation is the receiving of the electrical signal;
charging and energizing the energizable actuator of the governor with electrical power in response to the received electrical signal; and
maintaining the energizable actuator in an energized state from the time of activation to the time of reset,
wherein the electrical signal is provided from an electrical trigger mechanism located proximate the pit of the elevator shaft.

12. The method of claim 11, wherein the governor is a car-mounted governor attached to the elevator car.

13. The method of claim 12, wherein the electrical trigger mechanism is electrically connected to the car-mounted governor by a traveling cable.

14. The method of claim 11, wherein the governor is arranged in a machine room of the elevator system.

15. The method of claim 11, wherein the electrical trigger mechanism is at least one of a button, a switch, a lever, or a pull-cable located in the pit.

16. The method of claim 11, wherein the electrical trigger mechanism comprises a landing door lock at a landing door proximate the pit of the elevator shaft.

17. The method of claim 11, further comprising detecting an open state of a lowest landing door along the elevator shaft and detecting that the elevator car is not present at the lowest landing door, and, in response to detecting the lowest landing door is open and the car is not present, causing the governor to be activated.

18. The method of claim 11, wherein the time of reset comprises a manual resetting of the car-mounted governor.

19. The method of claim 11, wherein the car-mounted governor is configured to allow upward movement of the elevator car after the energizable actuator is energized.

20. The method of claim 11, wherein the energizable actuator is a solenoid.
